(19) United States
(12) Patent Application Publication
(10) Pub. No.: US 2010/0153189 A1
(43) Pub. Date: Jun. 17, 2010

(54) Method and apparatus for processing responses from a remote, live audience

(76) Inventors: Noah Labe Dudley, Los Angeles, CA (US); William Gibbens Redmann, Glendale, CA (US)

Correspondence Address: WILLIAM G. REDMANN, 1202 PRINCETON DR., GLENDALE, CA, 91205, US

(21) Appl. No.: 12/653,587

(22) Filed: Dec. 16, 2009

Related U.S. Application Data
(60) Provisional application No. 61/201,985, filed on Dec. 17, 2008.

(51) Int. Cl. G06Q 99/00; H04H 60/33; G06Q 50/00

(52) U.S. Cl. 705/12; 725/13

(57) ABSTRACT

A system and method for audience participation with a broadcast, such as a radio or television program distributed via terrestrial or satellite broadcast and IPTV multicast, is described. The system provides a distributed application architecture that self-organizes the audience's computers, including PCs, mobile devices, and set-top boxes, so that they work together and distribute the audience-participation communications and processing load so as to not overburden any one machine or communication channel. This same technique ensures that no over reliance is placed on one machine or channel. The system is arbitrarily scalable, without requiring significant infrastructure enhancements, with o(log n) response times. This allows live, real-time audience interactions such as voting or participation as a contestant, with live, real-time feedback to the studio originating the broadcast.

### CROSS REFERENCE TO RELATED APPLICATIONS

This application claims the benefit of U.S. Provisional Application No. 61/201,985, filed Dec. 17, 2008.

### FIELD OF THE INVENTION

The present invention relates generally to a system and method for interacting with a live, distributed, audience.

### STATEMENT REGARDING FEDERALLY SPONSORED RESEARCH OR DEVELOPMENT

Not Applicable

### REFERENCE TO COMPUTER PROGRAM LISTING APPENDICES

Not Applicable

### BACKGROUND OF THE INVENTION

Present day television audiences are encouraged to visit a broadcaster's or television program's website for further information, similar to the ‘bonus materials’common on DVD releases. Such further information, for example, may including conversations with the show's actors, directors, etc., or streaming replays of past episodes.

For some shows, the call to visit a site is real-time. In the hit television show “Dancing with the Stars,” (DWTS) produced by BBC Worldwide Ltd of London, UK, at the conclusion of the show, the television audience is asked to vote online, or by telephone, for their favorite performer. The results are reported the following evening.

Unfortunately, in a condition aptly described as “failure by success,” the web sites and telephone voting systems choke on the volume of traffic generated by this invitation for interaction. Of the 20+ millions of viewers, many of the would-be voters are frustrated. Fan sites of the show are peppered with complaints like “could not get through again,” and “phones and internet [sic] is jammed.”

One fan, “glassyaya” contributing on the community.tvguide.com website, laments “I called constantly and never got through until Len's voice came on to tell me that voting was over for my time zone.” Such frustrating experiences will dissuade an audience from participating, and the audience (and corresponding revenues) for such shows consequently will be capped and the would-be participating audience keenly unsatisfied.

The answer is not in better planning, the show has just finished its fifth season in the United States, and is still suffering the same failure modes.

The answer is not more infrastructure (e.g., servers and telephony equipment); a successful show is presumably properly budgeted. It is uneconomical if, when not in use, arbitrary quantities of equipment and telecommunications bandwidth lie idle. Instead, a budgeted quantity of infrastructure is leased for a short usage interval, dedicated to the real time event. The equipment is then released to other uses. Thus, the amount of equipment and communications bandwidth available for short term usage is still fundamentally limited.

The situation is even more difficult for a local or first season show, where there is no good way to estimate the degree of success, the potential size of the audience, the portion of the audience that will interact. Further, there is little or no additional budget with which to scale the interactive service.

### OBJECTS AND SUMMARY OF THE INVENTION

The present invention relates generally to a system and method for audience participation with a broadcast, such as a radio or television program, including an IPTV multicast. The system provides a distributed application architecture that self-organizes the audience's computers so that they work together and distribute the communications and processing load so as to not overburden any one machine or communication channel. This same technique ensures that no over reliance is placed on one machine or channel.

Herein, the term ‘broadcast program’ is intended to mean an audio or video media program, intended for distribution to a large audience, regardless of the means of the distribution. Television and radio programs are examples of such broadcast programs, whether distributed by terrestrial broadcast, satellite, cable, the Internet, etc.

There is a need for a way to satisfy real time audience interactivity that is both inexpensive and quickly and arbitrarily scalable.

Further, the inventors believe there is a latent need for new modes of interaction, which because of the limitations imposed by present methods, have never been realized.

One such latent need is for real time, in-show interaction. Presently, massively popular shows such as DWTS must present their results 24 hours later. There is a need for a way to provide similar interaction, but live, during a show.

Such interaction need not be limited to voting on a multiple choice question (such as DWTS, “who, among these, is your favorite dancing couple”), but may also include fill-in-the-blank, or still more complex responses.

There is a need for additional program formats, including game shows, which allow the audience's participation to expand into the role of contestant.

Prior art systems and methods such as taught by Iwafune et al. in U.S. Pat. No. 5,880,720, Iatropoulos et al. in U.S. patent application Ser. No. 09/766,380, and Pijper in U.S. patent application Ser. No. 10/526,212 all suffer from the constraints of expensive, but limited equipment. Each of these prior systems will fail under the burden of success.

The present invention satisfies these and other needs and provides further related advantages.

Hereinafter, the term ‘participating audience’ refers to those viewers of a particular broadcast program who are participating using the invention herein described. The term ‘candidate audience’ refers to those viewers who are equipped to participate in a particular broadcast program using the present invention, whether or not they are not actively participating. Thus, a person who has an set-top box programmed in accordance with the present invention, but who is not currently watching the particular broadcast, or is watching passively, is a member of the candidate audience, but is not a member of the participating audience for the particular broadcast. A person may be a participating audience member for one broadcast program while being a candidate audience member for many other broadcast programs.

It is an object of the present invention to enable audience participation with a broadcast program.

It is an object of the present invention to allow audience participation in near real time.

It is an object of the present invention to provide real time integration of the audience response into the broadcast program.

It is an object of the present invention to provide audience participation without suffering a data processing bottleneck by distributing the processing burden to the computers of the participating audience or candidate audience.

It is an object of the present invention to provide audience participation without suffering a communication bandwidth bottleneck by partially consolidating data returned from the audience on the computers of the participating audience or candidate audience.

It is an object of the present invention that the audience's computers may include personal computers, set-top boxes, and wireless, network connected devices such as data-enabled cell phones or a personal digital assistants (PDAs).

It is an object of the present invention to influence the audience to view a broadcast in near real time.

It is an object of the present invention to expose members of the participating audience to advertising.

It is an object of the present invention to allow the audience participation to be secure and fraud resistant.

It is an object of the present invention to allow the audience participation to be associated with the corresponding audience members so that individual audience member contributions or achievements can be determined.

It is a further object of the present invention for audience participation to include being a contestant in a game.

It is a still further object of the present invention for a participating audience member to win prizes as a result of their participation.

It is an object of the present invention to support tracking and squelching of rude or inappropriate responses from participating audience members.

It is an object of the present invention to support audience participation (without limitation) in the forms of multiple choice questions, including true/false questions, fill in the blank, single word, numerical, or short response questions.

### BRIEF DESCRIPTION OF THE DRAWINGS

The aspects of the present invention will be apparent upon consideration of the following detailed description taken in conjunction with the accompanying drawings, in which like referenced characters refer to like parts throughout, and in which:

FIG. 1 is a physical network diagram with an overlay network implementing an application hierarchy;

FIG. 2 is a block diagram of several stations implemented with set-top boxes;

FIG. 3 is a block diagram of several stations implemented with mixed station and communication technologies;

FIG. 4a is a listing of an operational graph, or program, for posing a multiple choice question and retrieving the collective response of the participating audience, suitable for execution on an application hierarchy;

FIG. 4b shows messages generated in response to an exemplary elaboration of the multiple choice question operational graph;

FIG. 5 shows the elaboration of the multiple-choice question operational graph and the relationship between an application hierarchy and the elaboration of the operational graph;

FIG. 6 shows a user interface, as generated by a set-top box overlaid onto a broadcast;

FIG. 7a is a detailed flowchart showing the response merger and return process called for by the multiple choice question operational graph;

FIG. 7b is a detailed flowchart showing a response merger and return process for a fill-in-the-blank question operational graph;

FIG. 8a is a listing of an operational graph for posing a fill-in-the-blank question, suitable for execution on an application hierarchy; and,

FIG. 8b shows three messages generated in response to an exemplary elaboration of the fill-in-the-blank question operational graph.

While the invention will be described and disclosed in connection with certain embodiments and procedures, it is not intended to limit the invention to those specific embodiments. Rather it is intended to cover all such alternative embodiments and modifications as fall within the spirit and scope of the invention.

### DETAILED DESCRIPTION OF THE INVENTION

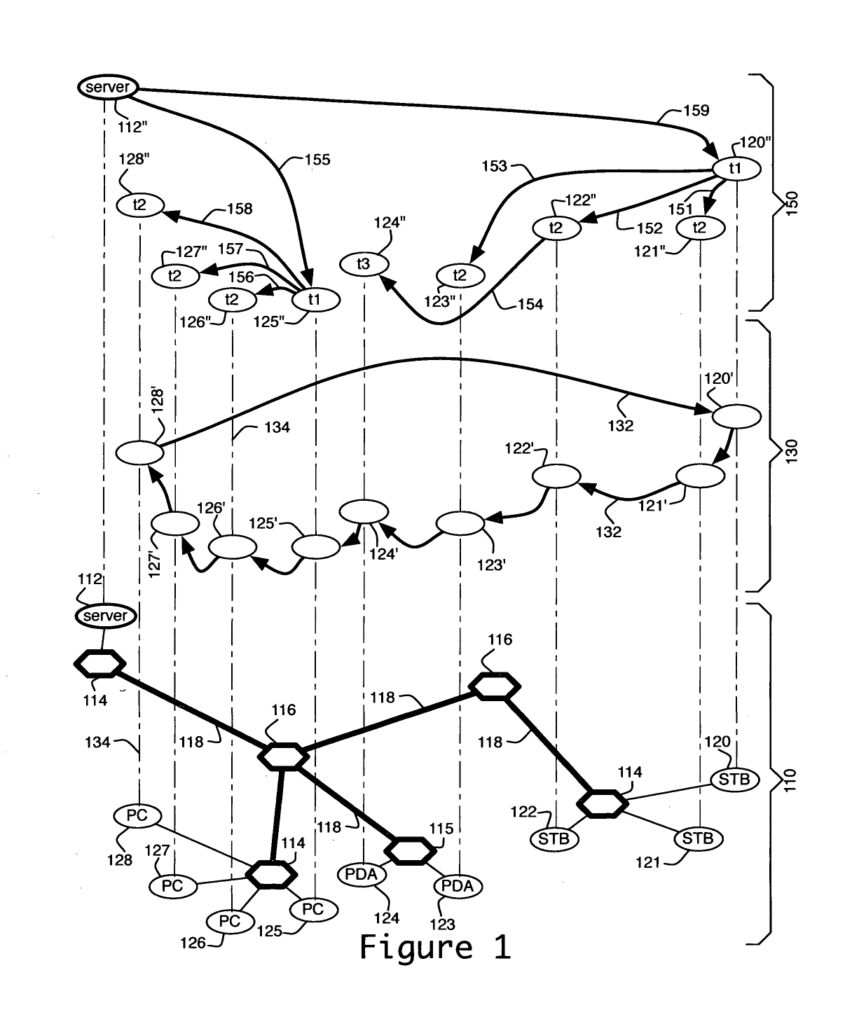

Referring to FIG. 1, an underlying, exemplary physical network 110 is shown. Physical network 110 comprises computers 120-128 which are the candidate audience computers. Audience computers 120-128 may be homogeneous or heterogeneous. Computers 120-128 may be, without limitation, personal computers (PCs), set-top boxes (STBs), or wireless, data-enabled devices such as cell phones (PDAs). In a typical implementation, there may be thousands or millions of audience computers, however for clarity, only these few are included in the following discussion and corresponding figures.

Computers 120-128 are preferably connected to the Internet or other wide-area network (WAN) by service provider nodes 114, 115. The connection from computers 120-128 to service provider nodes 114, 115 may be wired or wireless, or a mix thereof.

For example, in the case of a personal computer, such as a laptop, an audience member may have a wireless local area network (LAN) within the audience member's house, and from there a DSL or cable modem connection to their Internet Service Provider (ISP), such that service provider node 114 comprises the ISP equipment. Note that the wireless nature of LAN is arbitrary, and that a wired LAN connection to the DSL or cable model would be equally effective.

Another example is a data-enabled cell phone, which may have a wireless connection to service provider node 115 comprising a cellular telephone tower and the telephone company network equipment to which it connects, which provides connection 118 such that the cell phone has access to the Internet or other WAN.

Switching nodes 116, well known in the art, connect among service provider nodes 114, 115 and other switching nodes 116 by connections 118.

Physical network 110 preferably includes a server 112 connected to the Internet or other WAN by a service provider node 114.

This exemplary physical network 110 and the details of the equipment and interconnections it comprises will be recognized as encompassing many forms of network interconnection and that many other network configurations can provide interconnections suitable for the present invention. It would have been suitable to illustrate the physical network 110 as computers 120-128 and server 112 all with a connection into the well-known “Internet cloud” symbol. However, there can be an advantage when certain computers, for example computers 125-128, connect to a common node and share a common subnet. In such a situation, an implementation can exploit the low latency, low cost communication typically found among computers sharing a subnet. An exemplary technique for this implementation is described below, but is not a requirement for the practice of the present invention.

Each of the computers 120-128 in physical network 110 become members of self-organizing structured overlay network 130. Self-organizing network 130 has the advantage of minimizing the computational and communications burden on any one device or group of devices, such as server 112.

To join structured overlay network 130, a computer must know the address of at least one member node already in the structured overlay network 130. In general, this reduces the required interaction between a newly joining computer and server 112 to a single query requesting the address of any current member of overlay network 130. Once any member of overlay network 130 is known, the newly joining computer can query the known node for the newly joining node's appropriate position within the overlay network 130.

In an alternative embodiment, server 112 may be implemented as a plurality of servers (not shown), any of which may be queried regarding current members of overlay network 130. In still another embodiment, the function of server 112 to direct a newly joining computer to a member of the overlay network 130 can be provided by other means, for example a dynamic domain name server (dynamic DNS).

In some cases, a newly joining computer may have been previously a member of the overlay network and may still have a record of one or more members of the overlay network from that time, in which case those members could be contacted directly to see if they are still connected, or if they can provide the address of one or more computers likely to still be members of overlay network 130. This is particularly valuable if there is a momentary disruption in a connection and the newly joining computer is actually just re-joining a substantially intact overly network 130 to which it had been a member moments before.

Various classes of self-organizing peer-to-peer networks have been developed. Of particular interest is the Distributed Hash Table, or DHT. The principles and exemplary uses of DHTs are described by Ali Ghodsi in Distributed k-ary System: Algorithms for Distributed Hash Tables, his PhD dissertation to the Royal Institute of Technology, School of Information and Communication Technology, Department of Electronic, Computer, and Software Systems, Stockholm, Sweden, December, 2006. Distributed Hash Tables, also known as ‘structured overlay networks’ (SON), are well suited to building scalable, self-managing distributed systems.

A different, but related organizing principle is taught by Boris Mejías, et al, of Université catholique de Louvain, Belgium, in Improving the Peer-to-Peer Ring for Building Fault-Tolerant Grids, CoreGRID Workshop on Grid Programming Model, Grid and P2P Systems Architecture, Grid Systems, Tools, and Environments, FORTH-ICS, Heraklion, Greece, Jun. 12-13, 2007.

These peer-to-peer overlay networks provide algorithms that permit an ad hoc group of stations, each of which only needs to know how to connect to at least one station already in the organization, to interconnect and manage their organization. Such peer-to-peer organizations have not previously been shown to support a polling or survey integrated with a broadcast program. However, the capabilities for self-organization and self-maintenance is exploited in the present invention to achieve an interconnection of nodes for communicating and processing audience responses among themselves in conjunction with a broadcast program without the need for excessive investment in server capacity and bandwidth being required for any central facility.

Thus, in one embodiment, self-organizing structured overlay network 130 is implemented as a distributed hash table (DHT) ring, and employs the algorithms for joining, leaving, querying, and maintaining the DHT ring, all well known in the art with example implementations described in the identified publications and elsewhere.

Referring still to FIG. 1, peer-to-peer network 130 is instantiated by each computer 120-128 as nodes 120′-128′, respectively. The structure of network 130 is maintained by successor links 132 among the nodes 120′-128′. Those skilled in the art or familiar with the above work by Ghodsi and others will recognize that predecessor links (not shown) and extended successor and predecessor links (not shown) used for maintenance and redundancy have been, for clarity, not shown.

Hosting lines 134 (illustrated as vertical projection lines) indicate the association between the computers 120-128 and ring nodes 120′-128′. Hosting lines 134 further extend to show the relationship between ring nodes 120′-128′ and corresponding application nodes 120″-128″ in application hierarchy 150. A similar hosting line shows the association between server 112 and the application node 112″ in application hierarchy 150.

In an alternative embodiment, server 112 may host a node (not shown) of overlay network 130. Under this embodiment, server 112, the corresponding node (not shown) of overlay network 130, and node 112″ of application hierarchy 150 would be similar to each other computer hosting nodes, with the exception that node 112″ is at the root of structure formed by application hierarchy 150, in the embodiment discussed, a k-ary tree.

Note that it is not a requirement that there be a one-to-one correspondence between overlay network 130, and nodes in application hierarchy 150. For example, there may be many nodes 120′-128′ in overlay network 130 than are in application hierarchy 150. Such would be the case where computers belonging to candidate audience members are already attached to overlay network 130, even before becoming a participating audience member when application hierarchy 150 is joined. In such a case, there might be no application hierarchy node 120″-128″ corresponding to one or more overlay network nodes 120′-128′. For the purposes of illustration, the application hierarchy 150 as shown in FIG. 1 is fully populated, having a corresponding application hierarchy node 120″-128″ for each node 120′-128′ in overlay hierarchy 130.

In one embodiment, the application node 112″ hosted by server 112 forms the root of a k-ary tree to which each application node 120″-128″ belongs. This k-ary tree is the one embodiment of application hierarchy 150. In this configuration, the root node 112″ connects to a few first-tier application nodes 120″ and 125″ (marked as ‘t1’ for ‘tier one’) through child links 159 and 155 respectively. Each first-tier application node may link to second-tier application nodes 121″-123″ and 126″-128″ (marked ‘t2’) with child links 151-153 and 156-158 respectively. In the same manner, second-tier application node 122″ can connect to third-tier application node 124″ (marked ‘t3’) through child link 154. Not shown for clarity of illustration are parent links, which are the inverse of child links 151-159.

In an alternative embodiment, nodes in application hierarchy 150 might also track grandparent and grandchild links, to facilitate maintenance of the application hierarchy in case of an unexpected failure of a computer 120-128.

An application hierarchy 150 may comprise many dozens of tiers. Preferably, when a k-ary tree is used to form application hierarchy 150, the maximum fanout from one node to its children is at least two, so to more quickly grow the number of nodes in the application hierarchy without greatly increasing the depth of the k-ary tree. Ultimately, the response time of the application hierarchy is related to this depth, since any message must pass from the root to the deepest tier of the hierarchy by passing from tier to tier. For this reason, the response time of the system is said to be o(log n), where n is the number of the nodes in the tree, and the base of the log function is k, the fanout of the k-ary tree, whereby (log n) is, for the purposes of anticipating computational complexity, the average depth of a k-ary tree having n nodes.

Preferably, when application nodes are added to the k-ary tree, they are inserted to favor a balanced tree. However, circumstances may occur where the constraints of fanout for some nodes may result in a configuration where certain portions of the tree are unbalanced. The tree may be locally balanced by insertion and maintenance algorithms, but may allowably be globally unbalanced. For instance, assuming that application nodes 123″ and 124″ have not yet joined hierarchy 150 and that root node 112″ will not accept more than the two children 120″ and 125″, then when application node 123″ joins, it is referred to or must find a first-tier (or greater) application node with which to connect. As shown, application node 123″ becomes a child of first-tier node 120″. In a similar manner, when application node 124″ attempts to join, if first-tier nodes 120″ and 125″ will accept no more children, then application node 124″ must join as a child of a second-tier (or greater) application node, in this case application node 122″, and begin in the third-tier (or greater).

As nodes 120′-128′ join and leave overlay network 130, the DHT ring is retained. If elements of the physical network 110 fail, such as a crash of a computer 120-128, dropped connection to communications node 115, loss of power, or unexpected shutdown, the DHT ring maintenance functions carried out by and among the remaining overlay network nodes and will converge on a restored ring.

At the same time, as nodes 120′-128′ join and leave overlay network 130, the corresponding application nodes 120″-128″ join and leave application hierarchy 150 using well-known algorithms for tree node insertion and removal. The insertion in application hierarchy 150 can follow the joining of overly network 130, but the removal from application hierarchy 150 preferably precedes leaving overlay network 130. In the case where a node failure is detected by the DHT ring maintenance algorithm, the immediate children of, the corresponding failed application node attempt to rejoin the application hierarchy. If grandparent links (described above) are available, the children may attempt to rejoin at the grandparent node.

In an alternative embodiment, the immediate children of a failed node may search the overly network 130 for any appropriate point to reconnect, preferably at the same tier, or one closer to the root node 112″, since this will assure that no loops are formed in application hierarchy 150. However, so long as an application hierarchy node does not rejoin as a child of its own descendent (which would violate the hierarchical structure by leaving the affected segment unconnected to the root node), the child of the failed node can rejoin anywhere, as long as other constraints (e.g., predetermined fanout and maximum depth limits, if any) are obeyed.

As an example to show how many participants might be supported in accordance with the present invention, consider first a modest communication latency between tiers to be 100 mS. On the Internet, in the United States, this latency might represent a connection between two nodes 1000 miles apart.

The response time of application hierarchy 150 is defined as the amount of time required for a message to propagate from the server 112″ to the every node in the hierarchy 150, and back again, not counting any local processing time, nor human audience response time.

Now suppose that a requirement for a particular implementation is that the response time of the application hierarchy not exceed three seconds, that is, 1.5 seconds for the propagation or a query, and 1.5 seconds for the return of the response. If the expected communication latency between tiers is 100 mS, this would correspond to an application hierarchy not exceeding fifteen tiers.

Consider now the case of a binary tree implementation of the application hierarchy: a k-ary tree where k=2. In the first tier, t=1, there are two application nodes connected to the server, k raised to the t power, 2̂1=2. By the second tier, t=2, there are four application nodes, 2̂2=4, plus the nodes of the prior tier, for a total of 6 nodes. Continuing this calculation to the fifteenth tier, t=15, there can be as many as 65,534 application nodes in a perfectly balanced tree.

By simply increasing the value of k by one, to make a 3-tuple tree, the first tier contains 3̂1=3 nodes, by the second tier, there are 12 (3̂2=9 in the second tier, plus those in the first). By the fifteenth tier, still not exceeding the design requirement for a three second response time, almost 2.4 million nodes can participate in the application hierarchy 150.

In an ‘extreme’ case, with a fanout limit of merely five, to produce a 5-tuple tree, the fifteenth tier would support 38 billion nodes, or more than five nodes for every person on the planet. And still the response time of the application hierarchy is three seconds. If we were to presume that each of Dancing with the Star's 20+ million viewers each submitted ten votes in the hour following the show, the system needed to support such a capability would require about 55,600 votes per second. This estimate is high (not all 20+ million viewers vote), and the actual system is known to not support the actual (lesser) demand. However, the 5-ary application hierarchy described above would support 38 billion votes in three seconds, or 12.7 billion votes per second, and improvement over the prior art of more than five orders of magnitude!

As will be described below, the computational and communication burden imposed by the present invention on each of these application nodes is quite modest for even for values of k that are not very small. Note that the description in the prior example of the 5-ary tree was characterized as ‘extreme’. This was not due to the fanout of five, but rather because the ultimate number of application hierarchy nodes so exceeded the world population. In practice, a fanout of substantially greater than five would be supported easily, though for robustness sake, a modest fanout is usable with the excess capability dedicated to improving robustness through communication with other parts of the hierarchy in preparation for possible node failures.

In general, server 112 is expected to be a high reliability server with a high capacity communications bandwidth. Such a server might support a greater fanout, say 10 or 20, which can reduce the depth of the application hierarchy by several tiers, even when the rest of the nodes still only support a modest fanout such as those discussed above. However, this is not a requirement. If the resolution of requests for a joining node can be offloaded to separate components, such as a dynamic DNS (not shown) or other method as mentioned previously, then the function of root node 112″ provided by server 112 would be easily handled by a standard, consumer grade personal computer over a modest DSL line, and per the calculations above, handle an application hierarchy with billions of nodes, yet still maintain a response time of just a few seconds.

If the optimizations previously suggested of joining the DHT ring of overlay network 130 on the basis of IP address to cluster subnets, the typical node-to-node latency might be less than half that number.

In the case of a heterogeneous population of computers such as 120-128, those having severely limited bandwidth or computational ability may be constrained to join application hierarchy 150 as leaf nodes, and to remain as leaf nodes, that is, they would have no child links to other nodes. In this way, the bandwidth constraints of individual computers do not adversely affect the system. An example of a bandwidth-constrained computer would be a cellular telephone with data capabilities or a PDA. As for having enough locations in the application hierarchy 150 for leaf nodes to join, it is worth noting that in a well-balanced hierarchy of four or more tiers, the ratio of leaf nodes to interior nodes (application nodes having links to child nodes) is approximately k. So in a system having roughly five times as many participants using cellular phones with data capabilities or PDAs as their computers, as participants using laptop computers or set-top boxes, a system having a k-ary hierarchy of five, though preferably higher, could be expected to provide adequate capability. To illustrate the behavior of constrained bandwidth devices joining exclusive as leaf nodes, node 115 in physical network 110 comprises a cell phone tower and related networking equipment, while computers 123 and 124 are wirelessly connected to the cell phone tower of node 115. Note that in application hierarchy, corresponding application nodes 123″ and 124″ are each leaf nodes, that is, they have no children. Note that not all cellular telephone connections, especially as technology advances, will be characterized by limited bandwidth: This illustration represents a treatment for any computer 120-128 exhibiting a low bandwidth connection.

Note that an implementation of overlay network 130 in the form of a ring is representative of the well-known DHT overlay network, but that this implementation is not required. It is possible to implement application hierarchy 150 to also include the functions of the overlay network 130, e.g., joining, leaving, query, and maintenance. Such a modified implementation is considered within the scope of the present invention.

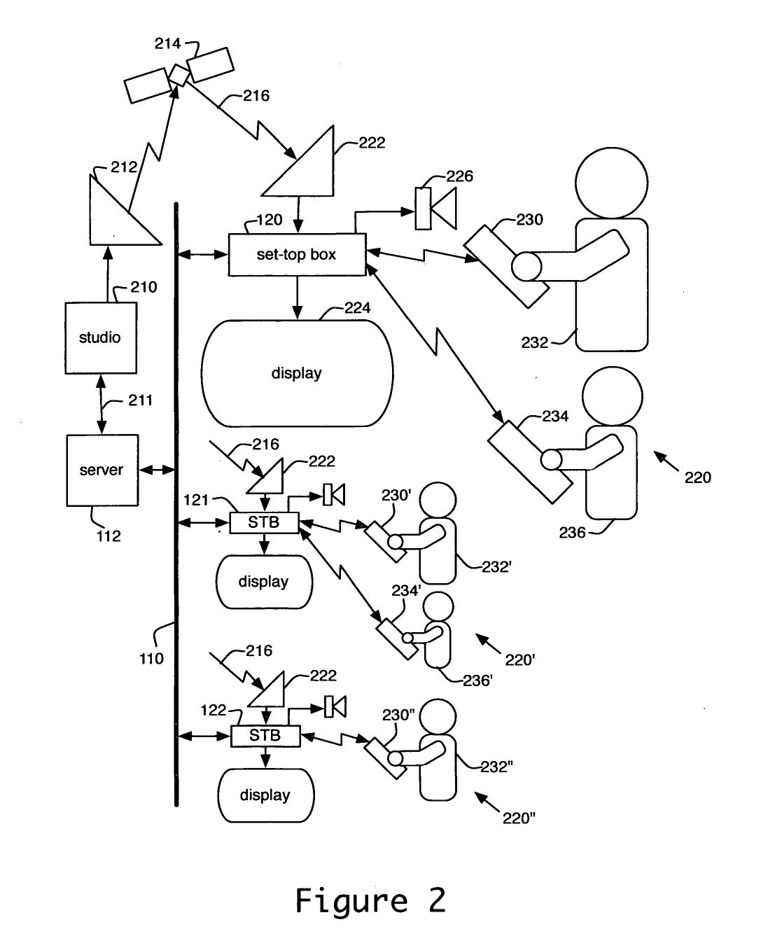

In the embodiment shown in FIG. 2, the computers 120-128 are implemented as set-top boxes. An advantage of using set-top boxes to implement the present invention is that set-top boxes rarely lose connectivity or get rebooted or shut down by their user, unlike a laptop which can be turned off, be hibernated, wander out of range of a wireless network, or just run out of battery power. In a comparison of two populations of computers, one comprising set-top boxes and the other laptop computer and cellular telephones, the former would have a much lower incidence of failure in physical network 110, and thus a much lower churn requiring maintenance by overlay network 130.

In FIG. 2, studio 210 sources a broadcast program and delivers it, preferably live, to head-end 212, in this case a satellite uplink. The broadcast program is relayed by satellite 214 as broadcast signal 216, which is received by each of set-top boxes 120-122 in households 220, 220′, and 220″, respectively, each set-top box having a connection to corresponding antennae 222.

A similar embodiment using set-top boxes for delivery of the broadcast program and communication of the participant's responses would employ a cable network (not shown) rather than the satellite 214 for delivery. In this case, the cable network would comprise at least a portion of physical network 110.

While broadcast signal 216 may comprise either audio or video programming alone, preferably the broadcast program is both. Thus, each set-top box 120-122 is connected to a corresponding display 224 and speaker 226. It does not matter whether the broadcast signal 216 is digital or analog in nature.

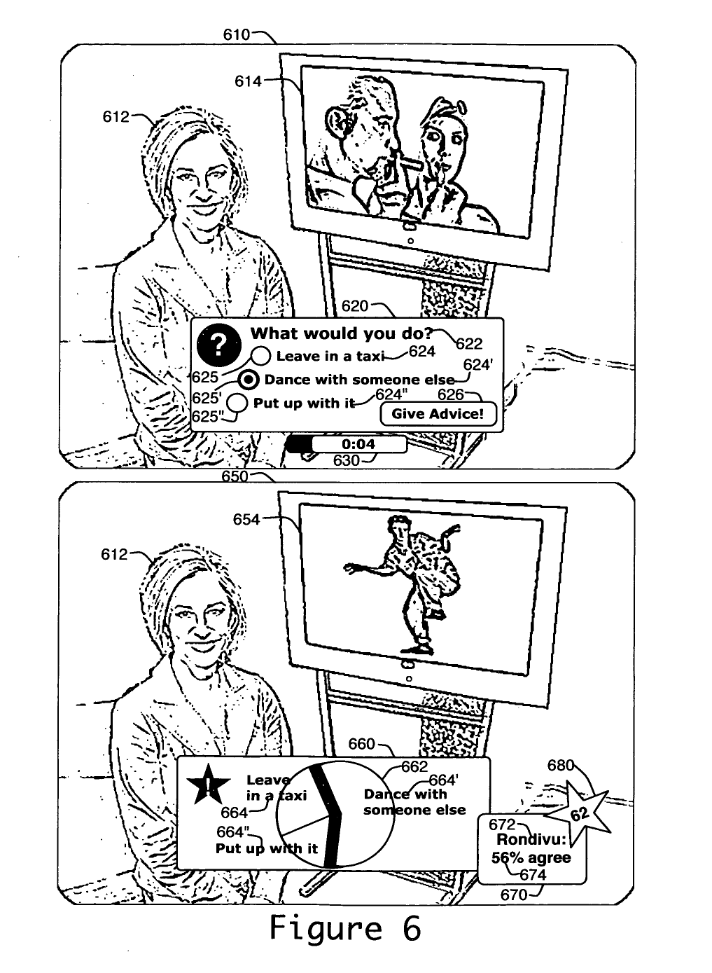

Each set-top box 120-122 is connected by physical network 110 to enable communication with each other and server 112. Preferably, server 112 has connection 211 to studio 210 so that the interactions prompted by server 112 can be directed from studio 210, and also so that the results delivered to server 112 through application hierarchy 150 can be provided to studio 210 to inform the production of the broadcast program, or to be displayed within the broadcast program as shown later in FIG. 6.

In household 220, participants 232 and 236 hold response devices 230 and 234, respectively. In household 220′, participants 232′ and 236′ hold response devices 230′ and 234′, respectively. In household 220″, participant 232″ holds response device 230″. Each response device has communication with the computer 120, 121, 122 in the corresponding households. The communication channel between the response device and the associated computer may be wired (not shown) or wireless (for example RF or IR) in nature.

By allowing multiple response devices 230 and 234 to interact with single computer 120, the whole family 232 and 236 can participate together during the same broadcast program. Alternatively, two or more members of a household can share a single response device 230.

When multiple response devices 230 and 234 are used, each preferably has a distinction, unique at least within household 220. For example, each response device might have a distinct identification code to be used in communication headers to identify the origin of a communication. Alternatively, each response device might use a distinct frequency of modulation, for instance if the communication channel to the computer is RF or optical. Of course, if wired, then each device is plugged into a unique port on computer 120.

If response device 230 employs a communication channel to computer 120 that might be received by computer 121 and mistaken as an input from 230′, then it is preferable for all such response devices to have a globally unique identification code.

In an alternative embodiment, multiple response devices 230 and 234 may connect to a common module (not shown) that provides the communication channel to the associated computer, and perhaps power. This allows the response devices to be light, not requiring batteries. The common module can also provide a caddy for holding the response devices when not in use. If the response devices remain wireless, the module preferably recharges batteries within the response devices.

Within the computer 120, responses from each response device 230 and 234 are preferably tracked separately. In this way, the responses of the respective participants 232 and 236 are tracked separately. This is particularly useful if each participant is receiving a score.

In still another alternative embodiment, a live, in-studio audience can also be members of the participating audience. Server 112 has communication channel 211 with studio 210, which is generally used to report the aggregate responses of the participating audience to the studio 210. However, communication channel 211 can allow participants in studio 210 to provide responses using individual response units (not shown) detectable by server 112, or another computer (not shown) providing a node the application hierarchy 150.

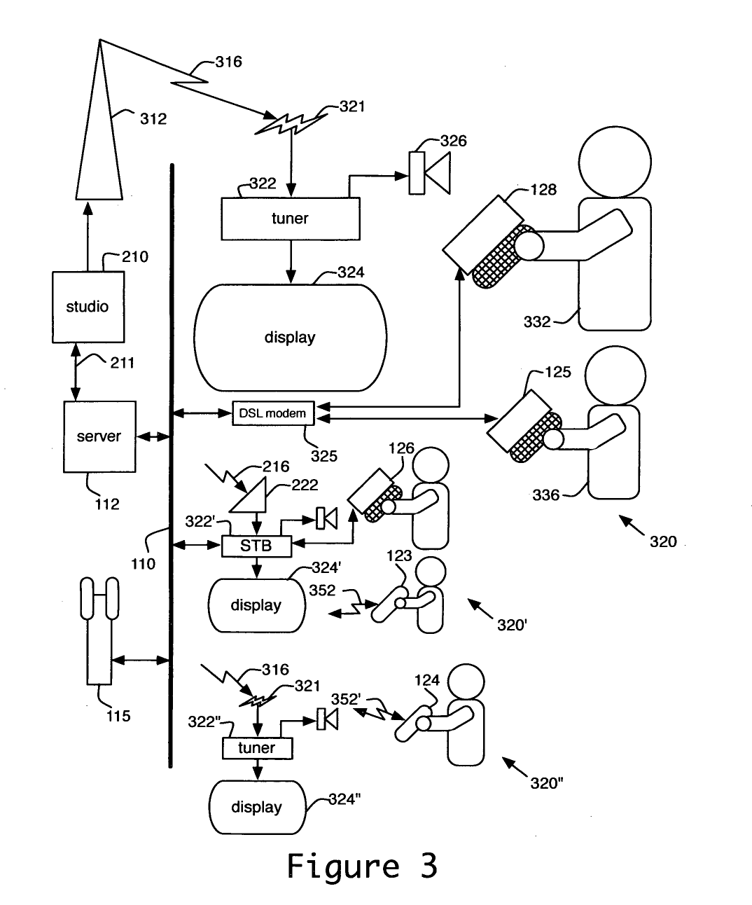

In FIG. 3, an implementation emphasizing heterogeneous stations is shown. In this case, the broadcast program from studio 210 is fed to a terrestrial broadcast tower 312. This does not preclude a substantially simultaneous feed to satellite or cable systems for parallel delivery to other participating households, such as those shown in FIG. 2.

Broadcast signal 316 is received in household 320 by aerial 321 and demodulated and decoded by tuner 322, feeding speaker 326 and display 324. In household 320, participants 332 and 336 use personal computers 128 and 125, respectively. Personal computers 128 and 125 are preferably laptop computers, and preferably have a wireless connection to DSL modem 325.

In an alternative embodiment, any or all of computers 120-128 may receive the program from studio 210 over connection 211 to server 112 and from there through physical network 110 (which may comprise the Internet) preferably using an Internet Protocol Television (IPTV) stream, such as MPEG2 over a Real-time Transport Protocol (RTP) multicast, all well-known in the art.

In household 320′, set-top box 322′ receives satellite broadcast 216 with antenna 222. Participant computer 126 obtains a connection to physical network 110 through set-top box 322′. Participant computer 123 is a cellular telephone or PDA having wireless connection 352 to node 115 comprising a cellular telephone tower.

In household 320″, tuner 322″ receives terrestrial broadcast signal 316 with aerial 321. Participant computer 124 has a wireless connection 352′ to node 115 comprising a cellular telephone tower.

FIGS. 2 and 3, taken separately or together show elements surrounding the distribution of a broadcast program into households for viewing by participants who respond through computers attached to physical network 110. As shown in FIG. 1, these computers organize into an overlay network 130 and construct application hierarchy 150.

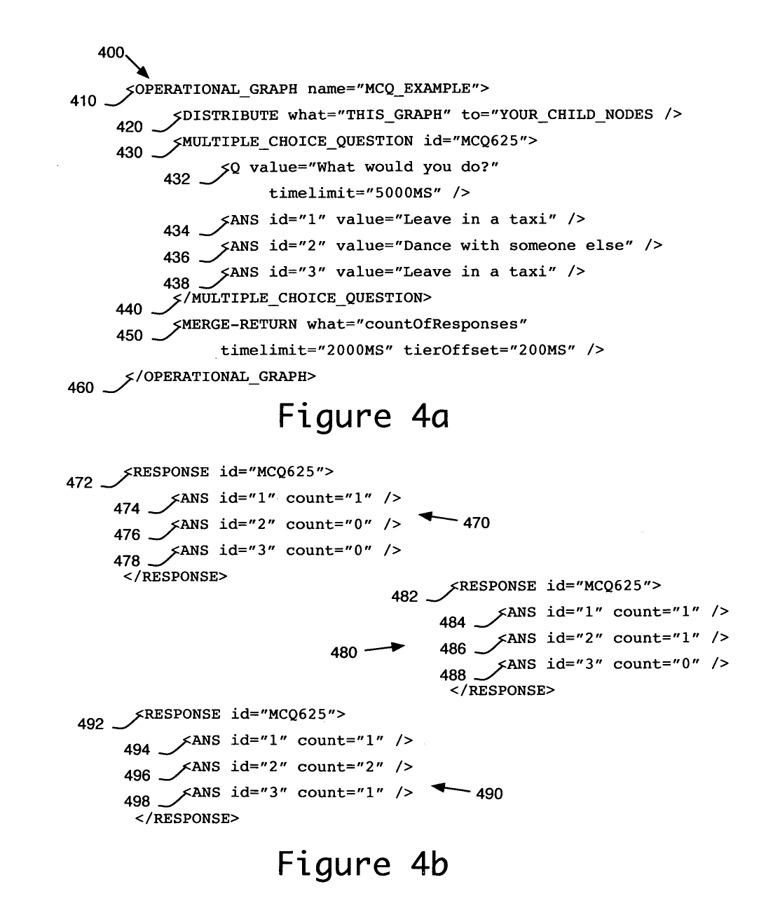

FIGS. 4a, 4b, 5, 6 and the following discussion provide a detailed description of the present invention as implemented using application hierarchy 150.

FIG. 4a shows an example operational graph 400 named MCQ_EXAMPLE, in XML pseudo-code. An operational graph is a computer program to be executed by an application hierarchy 150. While “computer program” is an acceptable term to describe the kind of instructions used to direct the nodes of an application hierarchy in performing a task, further use of the term is avoided herein for two reasons: First, because the code of the operational graph only operates in the context of an appropriate application hierarchy 150; and second, to avoid confusion with the “broadcast program” originating from studio 210.

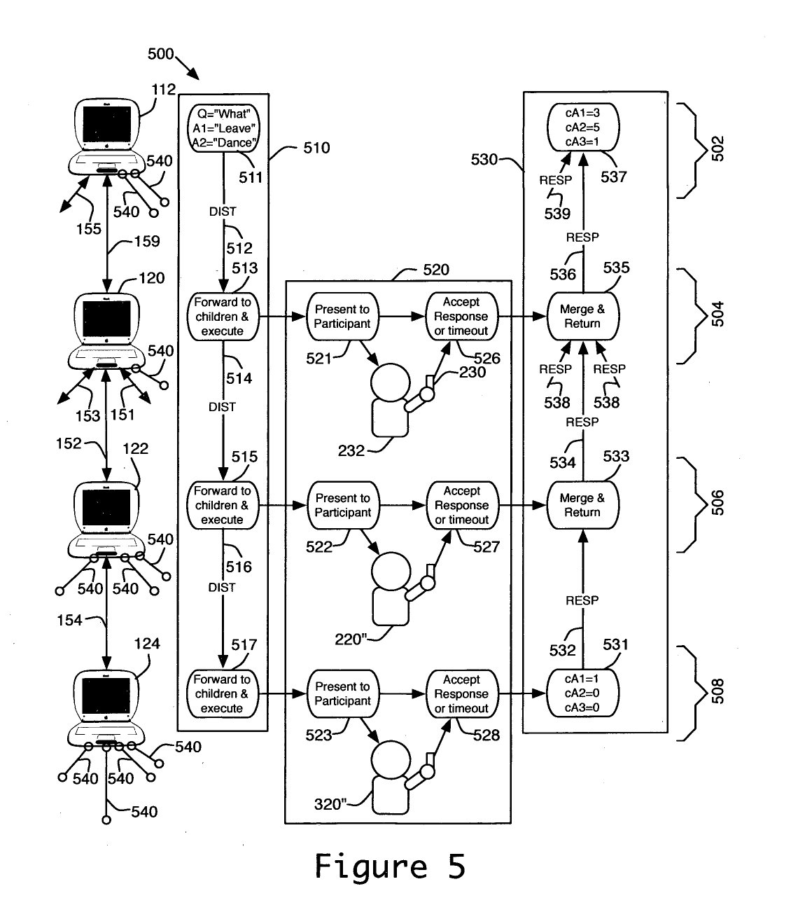

For this first example, along the left edge of FIG. 5 is shown a slice of application hierarchy 150 that includes server 112 and one exemplary station 120, 122, and 124 from each tier (t1, t2, t3) of application hierarchy 150. The remainder of FIG. 5 shows the elaboration 500 performed by application hierarchy 150 of operational graph 400, aligned to the tiers as represented by the exemplary stations. FIG. 6 shows the resulting presentation.

Preferably, operational graph 400 is expressed in a formally defined language, for example as by an XML schema. The design of a formal language, its grammar (XML or otherwise), and development of a parser and interpreter for reading and processing operational graphs expressed in the language are well within the ordinary skill in the art, given this disclosure. However, such rigorous definition (e.g., a schema) is not necessary to explain the principles of the present invention. Herein, an informal, XML-like, pseudo-code expresses the instructions necessary for this operational graph. Such pseudo-code is a practice well-known to students and software development teams to provide clarity to human readers, rather than the mechanical precision that a computer would demand.

The first tag 410 of the operational graph 400 indicates the beginning of an operational graph named “MCQ_EXAMPLE” and has a corresponding closing tag 460 which informs a computer (or human) reading the program of the program's endpoint. The body of the operational graph is comprised of the intervening elements.

The elements comprising the body of operational graph 400 are discussed in conjunction with FIG. 5, which illustrates the elaboration 500 of the operational graph 400 as it is executed and propagated through the tiers of application hierarchy 150. The elaboration 500 is shown complete with respect to application hierarchy 150 only in depth (i.e., all the tiers are shown), but not width: Only one of the nodes of each tier of application hierarchy 150 are shown. In FIG. 5, brackets 502, 504, 506, and 508 indicate rows corresponding to both physical equipment associated with tiers in application hierarchy 150, and the process steps occurring thereon: on server 112 as server node 112″, on computer 120 as application node 120″ in tier 1, on computer 122 as application node 122″ in tier 2, and on computer 124 as application node 124″ in tier 3.

Elaboration 500 comprises distribution steps 510, audience participation steps 520, and response collection steps 530; each of which correspond to elements 420, 430, and 450 in operational graph 400.

Distribution steps 510 are preferably initiated shortly before the interaction described by operational graph MCQ_EXAMPLE 400 is to be conducted with the participating audience. To initiate the interaction, application hierarchy node 112″ (for which the physical embodiment is server 112) sends a distribution via child links 159 and 155 to child nodes 120″ and 125″ residing on computers 120 and 125, respectively.

Empty child links 540 indicate available, but unused fanout at each application hierarchy node shown in FIG. 5, presuming a 4-ary tree (i.e., that each node in this example, including server node 112″, could support up to a modest four child nodes).

At the start of distribution steps 510, server node 112″ prepares or loads file or message 511, representing operational graph MCQ_EXAMPLE 400, to be sent in distribution (DIST) 512. Application hierarchy node 120″, on computer 120, receives distribution 512 and begins execution of MCQ_EXAMPLE 400. Other distributions by server node 112″ of file or message 511, such as to application hierarchy node 125″, are not shown in FIG. 5. In one embodiment, distribution 512 comprises MCQ_EXAMPLE 400.

In an alternative embodiment, MCQ_EXAMPLE 400 or a portion thereof may have been predistributed, perhaps by another means (e.g., a data disk such as a CD; or a download from a web site). In this alternative embodiment, distribution 512 comprises a reference to MCQ_EXAMPLE 400 or a portion thereof, plus whatever portion of MCQ_EXAMPLE 400 was not previously supplied (if any). Thus, distribution 512 could contain only question 432 and answers 434, 436, 438 and a reference (for example the name “MCQ_EXAMPLE”) to a previously distributed portion comprising the other lines of MCQ_EXAMPLE 400 such that the entire operational graph 400 can be reassembled. An advantage of this alternative embodiment is that the same framework for multiple choice questions could be used for any multiple choice question, but the data communication bandwidth would be approximately halved.

To be clear, the XML format of operational graph 400 is not necessary, nor in fact, is the transmission of the operational graph. Computers 120-128 may be previously programmed with the majority of the operational graph (recalling that an operational graph is a computer program for execution on an application hierarchy) and only the data (e.g., the questions and answers represented within the elements 432, 434, 436, and 438) or references to predistributed data would need to be distributed.

In other alternative embodiments, multiple choice answers 434, 436, 438 may be replaced with ‘true’ and ‘false’; ‘yes’ and ‘no’; or with answers of which one or more is ‘correct’, as opposed to opinion questions.

When node 120″ on computer 120 begins execution of operational graph 400, resulting in the performance 513 by node 120″ of distribution element 420 wherein node 120″ is instructed to forward “THIS_GRAPH” as distribution 514 to “YOUR_CHILD_NODES” which are accessible through non-empty child links 151, 152, and 153.

In turn, distribution 514 is received by application hierarchy node 122″ on computer 122 over child link 152. Node 122″ begins execution of MCQ_EXAMPLE 400 and in performance 515 of element 420, distribution 516 is forwarded to application hierarchy node 124″ over child link 154 (in this example, the only non-empty child link of node 122″).

Now in the third tier, distribution 516 is received by node 124″, which has no child links except for empty child links 540. Thus, performance 517 of distribution element 420 does not result in any further distribution of MCQ_EXAMPLE 400.

At this point, server node 112″ is awaiting the results of the interaction. Application hierarchy nodes 120″, 122″, and 124″ (and indeed, all the other application hierarchy nodes of the participating audience) have completed the distribution steps 510 and proceed to the audience participation steps 520.

Each of nodes 120″, 122″, and 124″ encounter in execution of their respective copies of operational graph 400, multiple choice question element 430. Multiple choice element 430 has an “id” with an arbitrary, but preferably unique, value of “MCQ625” which is used later in conjunction with response collection steps 530. Multiple choice question element 430 is terminated by closing tag 440.

Execution of multiple choice question element 430 requires a computer to present the question in element 432, as well as all of the answer choices 434, 436, and 438 for viewing and response by member of the participating audience.

If the computer performing the execution is a set-top box (and in this example, set-top boxes 120 and 122 from FIG. 2 are two of the computers participating), the presentation preferably takes the form of dialog box 620 in FIG. 6, overlaid into the current image 610 of the broadcast program. To provide a background or purpose for the audience interaction, example broadcast program 610 may include a live host 612 and/or a live or pre-recorded scenario 614 which may be real, fictitious, or hypothetical.

For computers 123-128 that are not set-top boxes, such presentation is preferably made on the screen of the computer or wireless device.

In an alternative embodiment, any of the computers may provide the presentation in an audio format, such as by using text-to-speech conversion software or including the appropriate audio media files in distribution 512. Further, the audience member's response may be selected with a voice recognition hardware and software of participating audience member's computer. This is especially well suited to PDA or mobile device embodiments.

In still another alternative embodiment, the presentation of the question and answers may be burned into the broadcast program, that is, a display similar to dialog box 620 could be provided by studio 210 on broadcast program 216 and 316. In this embodiment, the audience participation step 520 is not required to present the question and answers to the participating audience, as the broadcast program does this. However, the application hierarchy is still responsible in participation step 520 to collect the audience's responses.

In one embodiment, in dialog box 620, the value of question element 432 is displayed as query 622. The values of answers choices 434, 436, and 438 are displayed as alternative responses 624, 624′ and 624″. The time limit specified in question element 432 is initially shown in timer graph 630, which preferably begins counting down.

The presentation of the multiple choice question element 430 as described above occurs in presentation steps 521, 522, and 523 in FIG. 5 and for each of the other nodes in the corresponding tiers.

In the row designated by bracket 504, once dialog 620 is displayed to member 232 of the participating audience in step 521, member 232 uses response device 230 to communicate a response to set-top box computer 120. Such a response preferably includes selecting one of answers 624, 624′, or 624″ with a number key (not shown) on response device 230 which may correspond to the ID listed in answer elements 434, 436, and 438. Alternatively, up and down arrow buttons (not shown) on response device 230 may be used to make a selection among radio buttons 625, 625′, or 625″ corresponding to the answer choices 624, 624′, and 624″ displayed. In this example, participating audience member 232 has chosen answer 624′, as indicated by the highlighted radio button 625′ in dialog 620. To finalize the answer, member 232 may use control buttons (not shown) on response device 230 to select and click “Give Advice!” button 626, or an “OK” button or the like on response device 230 may commit the answer 624′.

In an alternative embodiment, dialog 620 may be modified to support multiple audience members 232 and 236 using separate response devices 230 and 234, or multiple audience members 232 and others not shown sharing a single response device 230. In such an alternative embodiment, dialog 620 presents multiple columns of radio buttons 625, 625′, and 625″ (only one shown), one column for each audience member using a response device (e.g., 230 and 234), and one column for each additional audience member (not shown) sharing a response device (e.g., 230). When sharing a response device 230, the response device may be passed between participating audience members sharing the device, or one audience member may enter responses for each of the sharing members.

Once committed, the answer is registered as the response in step 526. If member 232 fails to register an answer before the time limit from element 432 expires, the last answer selected is registered, or no answer is registered, according to the policy of the implementation, or according to an attribute (not shown) that could be specified in operational graph 400.

Contemporaneously, in the rows designated by brackets 506 and 508, multiple choice question element 430 is presented to the participating audience members 220″ and 320″ through their respective computers 122 and 124. The presentation of question element 430 to audience member 320″ is as a display on wireless device 124 and does not appear on display 324″. Also contemporaneously, the responses of other participating audience members 220″ and 320″, who were previously shown to be the users of computers 122 and 124, are gathered in steps 527 and 528; all respectively. So too are the responses of the other participating audience members in the portion of application hierarchy 150 not illustrated in FIG. 5.

After the response of member 232 is accepted or the time limit has expired in step 526, computer 120 has finished audience participation step 520 and begins execution of MERGE-RETURN element 450 in response collection step 530 by performing merge & return step 535. So far as is known to computer 120 at this point is that participating audience member 232 had selected answer 624′, which according to element 436 has id=2, thus giving id=2 a count of one and the other answer elements 624 and 624″ each a count of zero.

A similar process, performed at each of computers 122 and 124 has collected the response of their audience participants. In this example, assume that participating audience member 320″ responded with answer 624 (id=1) and that member 220″ responded with answer 624′ (id=2).

As application hierarchy node 124″ in row 508 has no active child links, computer 124 is able to complete execution of the response collection step 530 first, by performing step merge & return step 531. Only the response of member 320″ matters, since there are no child nodes for node 124″, so the response 470 shown in FIG. 4b is complete: The response element 472 begins a block comprising the answer counts 474, 476, and 478 of the originally offered multiple choice answers 434, 436, and 438. By noting that response element 472 has the “id” of “MCQ625”, the response is unambiguously associated with the original multiple choice question 430. With no child nodes, the response of member 320″ is in element 474 with a count of one, while the remaining elements 476 and 478 each have a count of zero.

In step 531, the response message 470 is sent to application hierarchy node 122″ on computer 122 as response (RESP) 532. At this point, computer 124 has completed execution of operational graph 400.

In row 506, upon receiving response 532, application hierarchy node 122″ on computer 122 stores the response 532 until merge & return step 533 is executing. If merge & return step 533 is already executing, response 532 may be handled directly. The ability to hold such a response 532 even before it is anticipated is useful where member 320″ answers more quickly than member 220″ and the execution of operational graph is correspondingly not so advanced on application hierarchy node 122″.

In merge and return step 533, the response 532 is accepted and the response of member 220″ is added to produce response message 480 having response element 482 reporting the same “id” of “MCQ625” and elements 484, 486, and 488; the first two of which have count=1 and the latter count=0. Response message 480 is sent in step 533 as response 534 to application hierarchy node 120″ at computer 120 and held there until merge & return step 535 is executing.

In merge and return step 535, the response 534 is accepted and the response of member 232 is added. Further, the response messages 538 from application hierarchy nodes 121″ and 123″ (connected by child links 151 and 153 respectively) are also added.

There is preferably a time limit within which a child node must respond. This time limit is preferably specified in the operational graph 400 in the MERGE-RETURN element 450 as the time limit attribute. This time limit is preferably further constrained by a tierOffset parameter. In this way, the communication from the bottom tier to the top tier is constrained to be 2000 mS as shown in MERGE-RETURN element 450. However, for each tier deeper in the application hierarchy, that communication constraint is reduced by 200 mS. In this configuration, a worst-case response at every level would limit the depth of the application hierarchy to ten tiers (2000 mS/200 mS per tier). As a practical matter, the average per-tier latency might be closer to 50-100 mS, so a depth of twenty tiers may be reasonably supported.

If each of the nodes connected to by child links 151 and 153 have responded timely, then the receipt of their responses 538, response 534, and the local response of participating audience member 232 can trigger the summation of the responses and the production of response message 490 as response 536. Response message 490 has response element 492 which identifies the multiple choice question “id” of “MCQ625” and includes the elements 494, 496, and 498 which report the counts for the three answers for all application hierarchy nodes under and including node 120″.

Response message 490 is returned as response 536 to server node 112″ on server 112, thus completing execution of step 535 by application hierarchy node 120″.

In step 537, response 536 is received and combined with the response message 539 from application hierarchy node 125″ connected to server 112″ by child link 155. The outcome of step 537 is that server 112 is able to calculate the final tally of all participating audience members by summing the counts of the individual answers from each of the received responses 536 and 539.

As a result, when elaboration 500 has proceeded for about seven seconds (from operational graph 400, the individual audience member time limit of 5000 mS from question element 432 plus the propagation time of 2000 mS from merge-return element 450), server 112 comes into possession of the response tallies. Response collection step 530 is complete. At this point, server 112 preferably relays the tally (step not shown) to the studio 210 over link 211. The resulting tally may be shown in within broadcast program image 650, for instance as dialog box 660 wherein pie chart 662 shows the relative popularity of answers 664, 664′ and 664″.

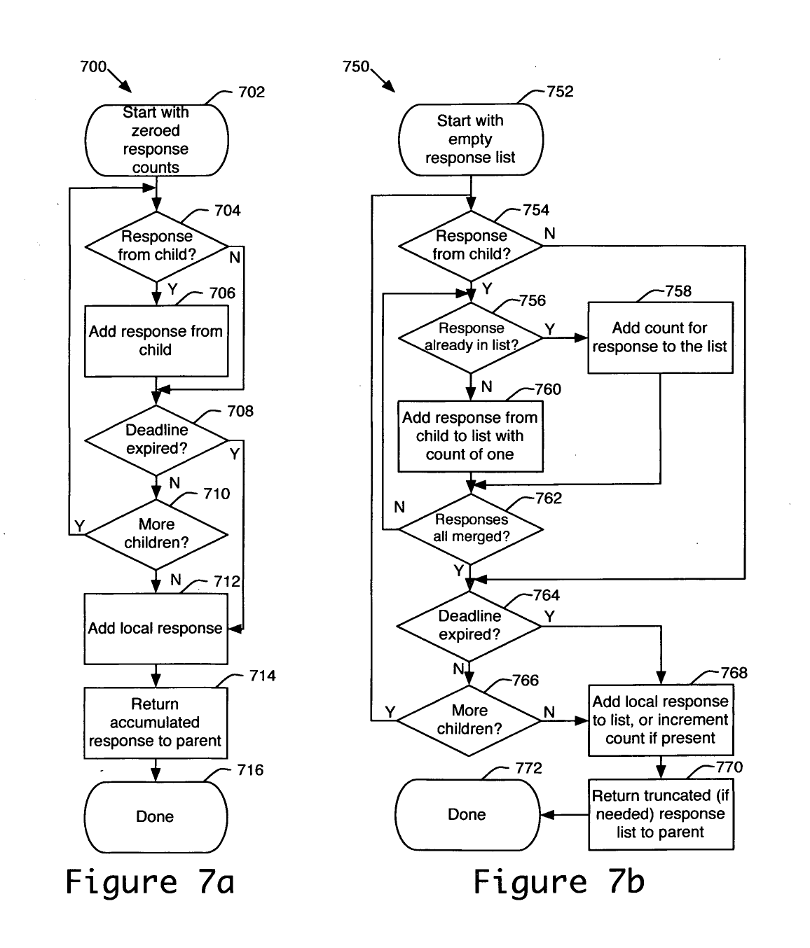

Preferably, an additional operational graph (not shown) propagates the resulting answer counts, for example in the manner of distribution 512. In a presentation step similar to 521, 522, and 523, but making use of the resulting answer counts, participating audience member results dialog 670 can be displayed by set-top box 120 over broadcast program image 650 with the member name or pseudonym 672. Other statistics, such as common response percentage 674 or running total of correct answers 680 also can be displayed. Such an operational graph can allow a member of the participating audience to be a contestant in a televised game, when the additional operational graph includes a merge & return step 530 that collects such statistics or running totals and selects a collection of the highest ones. A similar selection or filtering occurs in merge & return step 530 when implemented by process 750, discussed below in conjunction with FIG. 7b.

A set-top box 120-122 is a computer, and as such has memory which may keep track of each participant's status, responses, timings, and score. As appropriate, it may also track accounts and long-term statistics in non-volatile memory (e.g., a hard disk). This arrangement makes possible operational graph elements (not shown) that direct the computers 120-128 in application hierarchy 150 to hold the participating audience member's response and the speed with which that response was provided by the audience member. When the correct or most popular answer is provided, as for example in a subsequent operational graph that refers to the same question identifier (e.g., “MCQ625” in question element 430) then an operational graph element (not shown) can direct the computers to score the audience member's response, wherein the scoring function may consider not only the correctness of the response, but the speed with which it was given, too.

Also, a set-top box computer 120-122 may detect latency of display 224 of broadcast signal 216 from studio 210, and delay presentation activities 521 to more tightly synchronize the presentation of questions and collection of results with the broadcast program. Detection of such systemic latency by a set-top box 120-122 is achievable by analyzing the broadcast program for synchronization signals, for example embedded in the video, audio, blanking intervals, closed captions, or other metadata, which may be listed within operational graph 400, for instance as an attribute (not shown) within question element 432. For instance, presentation 521 of a question 432 might be withheld until the designated closed caption message (not shown) had been detected by the set-top box.

The most popular response 664′ may inspire some previously prepared presentation 654 or a comment from live host 612, provided by studio 210.

In the alternative embodiment mentioned earlier in which live, in-studio audience members participate and are provided with response devices (not shown) that communicate directly with server 112 implementing server node 112″, thus allowing server node 112″ to perform step 520 with the in-studio audience as participants. Note that in FIG. 5, for this alternative embodiment, there would be shown an elaboration of audience participation step 520 in row 502. In this embodiment, server 112″ is no different from any other node in application hierarchy 150, except that it does not have a parent node, though it does report the results of step 530 to studio 210.

In an alternative embodiment, the distributed application represented by operational graph 400 and running on application hierarchy 150 does not have to be affiliated with the broadcast program 216 and 316 from studio 210. In such an embodiment, connection 211 between studio 210 and server 112 is absent and the broadcast from studio 210, whether a live show or pre-recorded, merely serves as a backdrop to an independent interaction. For instance, a collection of operational graphs for asking and scoring trivia questions suitable, for example, to accompany the classic movie “The Wizard of Oz” could be prepared in advance, loaded onto server 112, and synchronized live to a presentation of the “The Wizard of Oz” broadcast by studio 210. For instance, an operator of server 112 might release each consecutive question (i.e., operational graph) based on broadcast 216 and 316 reaching a particular point in the movie.

In FIG. 7a is shown a more detailed view of multiple choice merge & return process 700 as performed in response collection step 530. Multiple choice merge & return process 700 would be executed by each node in application hierarchy 150 having a participating audience member. Instances of process 700 being executed occur in steps 531, 533, 535, and 537, and at other application hierarchy nodes not shown in FIG. 5.

Multiple choice merge & return process 700 begins at initialization step 702 where the local counts associated with each of the multiple choice answers provided in elements 434, 436, and 438 are cleared.

Receiving step 704 checks to see whether a response from a child node of the local node executing process 700 has been received. If so, merge step 706 adds the counts for each answer received in the response from the child node, to the local counts.

Preferably, as a part of merge step 706, the local node first confirms that the counts received from the child node correspond to the current question 430.

Further, for a given question, the counts received from a child should not be duplicatively included. That is, if the same counts are received twice from the same child, the latter counts should be ignored.

In an alternative embodiment of step 706, the local count can comprise the most recent counts reported by each child node. If the prior count received from the child is retained separately at the local node, then if an updated count is received from the same child for the same question, then the prior count can be subtracted from the total, the updated count added, and the updated count recorded for use in case of a still further update.

Whether or not a child response was available in step 704, deadline test step 708 determines whether the time limit specified in MERGE-RETURN element 450 has lapsed, including any offset for the tier in which the local node is located. If the deadline has expired, processing continues at step 712.

If the deadline has not expired, then in completeness test step 710, a test is made to check whether all child nodes have responded with their counts. If so, processing continues at step 712, otherwise the merge & return process 700 loops back to step 704.

In the alternative embodiment described above in conjunction with step 706, where child nodes may submit updates, completeness test step 710 would always loop back to await further responses or updates and deadline test 708 would be the only exit from this loop.

In local response step 712, the response or responses of the participants in this household are added to the local count. If the one or more of the participants in this household did not responded to the question before the time limit (e.g., from question element 432), then the non-responding participant's contribution to the counts is zero.

Thus, in return step 714, all timely-received responses from local participants and participants corresponding to descendant nodes in application hierarchy 150, are sent to the parent node of the local node. With receipt of this return confirmed, merge & return process 700 completes at step 716.

In an alternative embodiment, a periodic update step (not shown) would send an accumulated response to the parent node. This method is especially suited to questions having a longer time limit and would provide studio 210 with an early, progressive response from throughout application hierarchy 150, as more and more responses were tallied.

FIG. 4b shows the details of response messages 470, 480, and 490 corresponding to the responses 532, 534, and 536 respectively as produced by merge & return process 700. In each response message 470, 480, and 490, the corresponding response element 472, 482, and 492 provides the identifier “MCQ625” to indicate that these responses are for the multiple choice question element 430 in operational graph 400. Each response preferably provides a count for each of the provided answer elements 434, 436, and 438.

In response 532, the first answer count 474 is one, corresponding to the response of participant 320″, while the other counts 476 and 478 are zero. In response 534, the first answer count 484 is one, as a result of the count returned in response 532. The second answer count 486 is one, from the response of participant 220″. In response 536, the first answer count 494 is one, as forwarded in response 534; the second answer count 496 is two, the sum of the count forwarded in response 534 and the response of participant 232; the third answer count 498 is one, as forwarded in a response 538 from a different child node of application hierarchy node 120″. Evidently the other response 538 from the other child node of node 120″ was either all zero, or was late. Upon receiving response message 490, server node 112″ is able to complete the tally by combining response 536 with the response 539 from the node connected by child link 155.

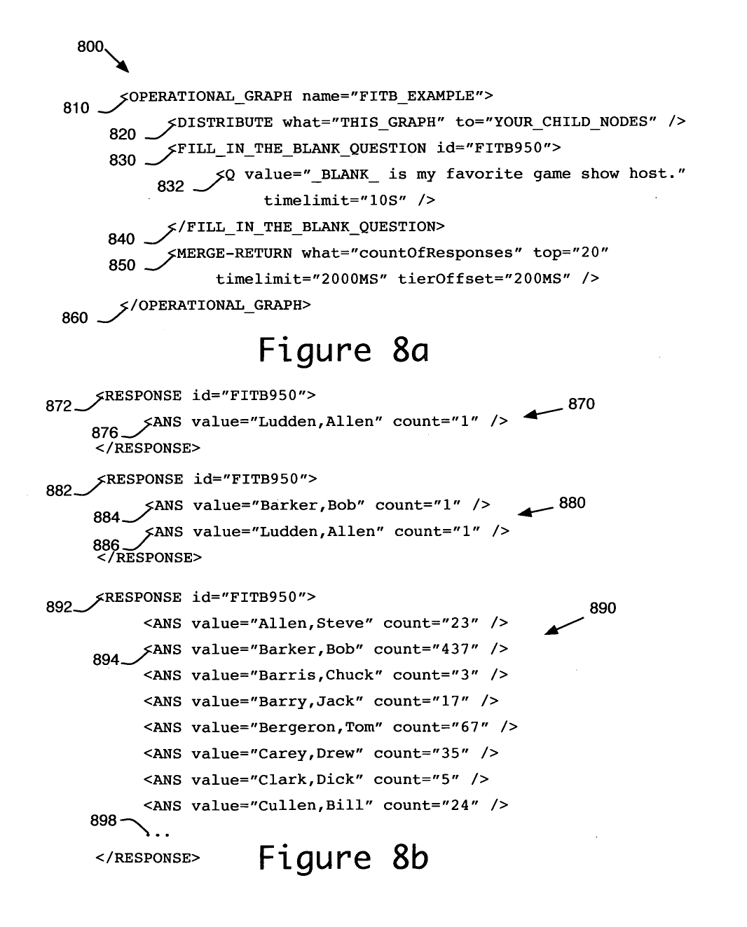

In FIG. 7b is shown a merge and return process 750 for use with fill-in-the-blank style responses where the participating audience does not select their answers from a pre-determined list, but instead provides a short form answer, typically one or two words. The fill-in-the-blank merge and return process 750 would be used for handling responses to a fill-in-the-blank style question, such as provided in the operational graph 800 in FIG. 8a.

The elaboration 500 shown in FIG. 5 would be substantially similar for operational graph 800. The operational graph begins with operational graph element 810 and closes with element 860. Operational graph element 810 provides the name FITB_EXAMPLE. Distribution element 820 is the same as distribution element 420, so distribution step 510 would proceed the same. Fill-in-the-blank question element 830 takes the place of multiple choice question element 430. While question element 832 is reminiscent of question element 432, no answer elements are provided! This is because rather than picking from a list of candidate answers, the participating audience members will enter the answers directly. Because longhand entry of an answer is expected to take more time than picking from a list, a longer time limit for the participant to provide a response is preferably specified. A significant departure is also seen in merge-return element 850: Though a count of responses is returned as before, an additional parameter is included to constrain the answers to the top, or most popular, 20 answers.

FIG. 8b provides several examples of response messages from nodes participating in the elaboration of fill-in-the-blank operational graph 800.

Response message 870, identified in response element 872 as being associated with fill-in-the-blank question element 830, would be appropriate coming from node 124″: As node 124″ has no child nodes, there is only a single answer element 876 having a count of one associated with the response provided by participating audience member 320″.

Response message 880 whose response element 882 is associate with the same element 830, is the result of the merging of response message 870 with the response of member 220″ in merge and return step 533, but using merge and return method 750, as appropriate for fill-in-the-blank questions.

Response message 890 is the result of further merges and represents the accumulation of many hundreds or thousands of audience responses (which requires a larger participating audience and application hierarchy than shown in the figures). Response element 892 associates this with the same fill-in-the-blank question 830, but now, answer 884 given by audience member 220″ is seen in answer element 894 to have accumulated a count of 437, indicating that many other participants have given the same answer. Ellipsis 898 indicates that only the first portion of the full set of answers is shown.

The full set of answers in response message 890 (or, indeed, any response message to question element 850) could number up to twenty (or more if there is a tie for 20th most numerous response), according to the constraint in merge and return element 850 to return only the top twenty answers. Such a constraint is applied to each subsequent response message

The method for performing the merge at each node in application hierarchy 150 is detailed as fill-in-the-blank merge and return process 750. In start step 752, the accumulated response list is empty. If a response message from a child node has not been received at step 754, then processing continues with deadline test step 764. Otherwise, each answer and count in the response message received from the child node is checked in examination step 756.

If the answer value is already present in the accumulated response list, then in accumulate step 758 the count for that answer value is raised by the count received.

However, if the answer value is not already in the accumulated response list, then the answer value is added to the list.

Note that examination step 756 can compare the literal alphanumeric text of the answers supplied by the individual participants, and accumulate those which are exact matches. Preferably all the alphabetic characters are upper case only, or where unimportant, the text provided by participants can ignore case in the comparison. In alternative embodiments, spell checkers or other algorithms can be employed (e.g., the Soundex algorithm as taught by Russell and Odell in U.S. Pat. Nos. 1,261,167 and 1,435,663).

Different algorithms for use in examination step 756 will be better suited to different kinds of expected answers. For instance, if the expected answer is an English adjective, then the algorithm may well use a spell checker employing an English language dictionary, and may further constraint its selection to adjectives. The spell checker may interactively assist the participant and be employed during audience participation step 420, but the interaction is optional and will be quicker if the spell checker performs the fix-up autonomously in examination step 756. Assuming the spell checker fails to find the word(s) provided by the participant, but has a high confidence factor in a particular correction, the correction can be made automatically with better reliability than leaving the unrecognized word. If, however, the confidence factor is insufficiently high, the system can forego the correction and include the word as submitted by the participant. In this way, spelling or typographic errors in participant answers can be overcome and participants who intended to provide a particular answer are not hampered when typing with a tight time deadline or otherwise taxed spelling skills.

Whether the answer value is newly added to the list in step 756 or the counts are added in step 756, processing continues at step 762 to determine whether there are more answers in the currently received response. If so, the process loops back to examination step 756 to handle the next answer. Otherwise, test step 764 determines whether the deadline has passed. If not, and if responses from more child nodes are expected in step 766, then the process loops back to step 754. But if the deadline is passed in step 764 or if no more child nodes are expected in step 766 to respond, then processing advances to step 768 where the response(s) of the local participant(s) are added, using the same decision process of steps 756, 758, and 760.

Finally, in step 770, the list is truncated to the top twenty responses, in accordance with the instruction in merge-return element 850. If there are fewer than twenty answers in the response list, then no truncation is needed. Whether ties for the twentieth place are retained or randomly selected can be a matter of policy, and may be controlled, for example, by a parameter (not shown) in merge-return element 850.

Preferably, when the response list is forwarded to the parent node in step 770, the answers records are sorted by the answer value, e.g., alphabetically. This allows evaluation step 756, wherever performed, to utilize a merge-sort, a particularly efficient algorithm for combining two sorted lists into a combined, sorted list.

With the resulting response list sent off to the parent node, fill-in-the-blank merge-return process 750 concludes with step 772.

Several progressive examples of a response list are shown in response messages 870, 880, and 890. Each has a response element 872, 882, and 892 that indicates an association with fill-in-the-blank question element 830, since the “id” is given in each as “FITB950”. Response message 870 contains the response of a single participant 320″ who answered “Allen Ludden” for favorite game show host. In this case, a user interface is presumed to have queried for first and last name, and provided a formal formatting as the response was encoded into the value of answer element 876. Response message 870 is sent from application hierarchy node 124″ to its parent, as with response 532.

When response message 870 is received at another application hierarchy node, e.g., 122″, the response of single participant 220″ who answered “Bob Barker” is added to the list in step 760 since “Bob Barker” isn't already in the list. The resulting combined response list is formed into response message 880, with new answer element 884 for “Bob Barker” and previously answer element 876 repeated as answer element 886 and having the same count as before.

At some point up the application hierarchy 150, though one with a significantly larger participating audience than shown in the figures, the response message 890 might be generated with many more responses accumulated, perhaps up to about twenty (from the limit in merge-return element 850). Ellipsis 898 identifies where the remaining answer elements (not shown) would be in the complete response message 890. Here, after at least one application of step 758 (on one or another of the application hierarchy nodes, including server node 112″) for each count that is not equal to 1, the response list represented by response message 890 has accumulated a count of 437 individual participating audience members' responses identifying “Bob Barker” as reported in answer element 894.

As with all such systems, the particular features of the user interfaces and the performance of the processes, will depend on the architecture used to implement a system of the present invention, the operating systems of the servers and computers selected, the bandwidth and other properties of the network, and the software code written. It is not necessary to describe the details of such programming to permit a person of ordinary skill in the art to implement the processes described herein, and provide graphical or interactive voice response interfaces suitable for executing the scope of the present invention. The details of the software design and programming necessary to implement the principles of the present invention are readily understood from the description herein. Various additional modifications of the described embodiments of the invention specifically illustrated and described herein will be apparent to those skilled in the art, particularly in light of the teachings of this invention. It is intended that the invention cover all modifications and embodiments, which fall within the spirit and scope of the invention. Thus, while preferred embodiments of the present invention have been disclosed, it will be appreciated that it is not limited thereto but may be otherwise embodied within the scope of the following claims.

We claim:

1. A method for collecting responses comprising the steps of:
a) presenting a question to an audience, said audience comprising a first plurality of members;
b) providing a second plurality of computers, each of said second plurality of computers having access to a physical network;
c) forming an overlay network on said physical network among said second plurality of computers;
d) forming an application hierarchy on said overlay network with at least a third plurality of computers of said second plurality of computers, wherein each of said first plurality of members has access to a corresponding one of said third plurality of computers, each of the third plurality of computers having an interface for collecting responses from the corresponding member;
e) executing an operational graph on at least said third plurality of computers, said operational graph comprising instructions for collecting a fourth plurality of responses to the question from at least a portion of said first plurality of members through the corresponding interface, said operational graph further comprising instructions for providing to at least one node of the application hierarchy a result, said result comprising a summary of said fourth plurality of responses.

2. The method of claim 1, wherein said operation graph further comprises instructions for distribution of said operational graph.

3. The method of claim 1, wherein said operational graph provides a time limit within which each of the responses is accepted.

4. The method of claim 1, wherein said application hierarchy is a k-ary tree.

5. The method of claim 1, wherein at least one of said second plurality of computers is a server, and said result is provided to the server.

6. The method of claim 5, wherein said application hierarchy is a k-ary tree and said server provides a root node of said application hierarchy.

7. The method of claim 5, wherein said server provides said operational graph to at least one node in said application hierarchy.

8. The method of claim 1, further comprising the step of: f) presenting at least a portion of the summary to the audience.

9. The method of claim 8, wherein said operational graph further comprises instructions to perform at least one of steps a) and f).

10. The method of claim 8, wherein at least one of steps a) and f) is performed with content viewable by said audience.

11. The method of claim 10, wherein said content is distributed by at least one of terrestrial broadcast, satellite, cable, and the Internet.

12. The method of claim 11, wherein said content is at least partially live.

13. The method of claim 12, wherein said content comprises a game show.

14. The method of claim 13, wherein at least a portion of said first plurality of members are contestants in said game show wherein the performance of each contestant is at least partially determined by the responses of the contestant.

15. The method of claim 10, wherein said content comprises a contest in which a winner is at least partially determined by said fourth plurality of responses.

16. The method of claim 1, wherein each of said second plurality of computers is selected from the group comprising a server, a PC, a set-top box, a data enabled cell phone, and a wireless, network connected personal digital assistant.

17. The method of claim 1, wherein step a) further comprises presenting a fifth plurality of choices to the audience, and said summary is a count of each choice in said fourth plurality of responses collected in step e).

18. The method of claim 1, wherein in step a) the question is a fill-in-the-blank, and in step e) said summary comprises a fifth plurality of counts of substantially similar responses in said fourth plurality, said summary further comprising for each count at least a representative one of said substantially similar responses.

19. The method of claim 18, wherein said fifth plurality is limited to a predetermined number.

20. The method of claim 1, said audience further comprising a fifth plurality of members, each having access to one of the third plurality of computers through the corresponding interface, said operational graph further comprising instructions for collecting a sixth plurality of responses to the question from at least a portion of said fifth plurality of members, said summary further of said sixth plurality of responses.
